(19) United States
(12) Patent Application Publication
(10) Pub. No.: US 2007/0029287 A1
(43) Pub. Date: Feb. 8, 2007

(54) ELECTROEROSION SYSTEM FOR THE PRODUCTION OF A CAVITY OR A SHAPED HOLE IN AN ELEMENT

(76) Inventors: Ugo Cantelli, Roma (IT); Giovanni Ballerini, Impruneta (IT)

Correspondence Address: GENERAL ELECTRIC CO.;GLOBAL PATENT OPERATION, 187 Danbury Road, Suite 204, Wilton, CT, 06897-4122, US

(21) Appl. No.: 11/461,529

(22) Filed: Aug. 1, 2006

(30) Foreign Application Priority Data
Aug. 2, 2005 (IT) MI2005A001518

(51) Int. Cl. B23H 7/38

(52) U.S. Cl. 219/69.2

(57) ABSTRACT

Electroerosion system (10) for the production of a cavity (22) or a shaped hole in an element (20) to be processed, the system (10) comprises a tank (12) containing a dielectric fluid (14) and an electrode (16) connected to an electric power supply system (18) to supply a high voltage to the electrode (16) and to produce a series of electric discharges on the element (20) which is immersed together with the electrode (16) in the dielectric fluid (14), in order to obtain a surface erosion thereof, forming the cavity (22), the system (10) comprises ultrasonic vibration means (30) capable of transmitting a series of ultrasonic waves at a varying frequency to the dielectric fluid (14).

### BACKGROUND OF THE INVENTION

The present invention relates to an electroerosion system in particular for the production of a cavity or shaped hole in a metallic element.

An electroerosion system generally comprises a tank containing a dielectric fluid in which an element is immersed. A cavity or shaped hole with very strict characteristics or dimensional tolerances, is to be formed in the element.

Said electroerosion system also comprises an electrode and an electric generator electrically connected to the same, which is positioned close to the element to be processed, and is therefore at least partially immersed in said dielectric fluid.

Said electric generator is capable of applying a voltage to said electrode producing an electric current which flows through said dielectric fluid and is discharged onto said element causing a localized erosion of a portion of the metallic element close to the electrode itself.

The localized erosion is a result of the extremely high temperatures which are produced at a local level on the surface portions of the metallic element, and in particular close to the electrode.

The eroded material consequently becomes detached from the surface of the element and remains in suspension in the dielectric fluid.

A cavity or shaped hole having certain characteristics is obtained over a period of time by means of a series of discharges and relative shifting of the electrode location with respect to the element.

A first drawback associated with prior art electroerosion systems lies in the fact that during the electroerosion, the particles of eroded material jeopardize the quality and efficacy of the electric discharges of the electroerosion system.

The reason for this is that said particles stagnate in the dielectric fluid and remain close to the surface of the element.

Another drawback of the known electroerosion systems is that with time a high concentration of eroded particles is formed along the element surface, diminishing the effectiveness of the electroerosion process and consequently the quality of the surface finishing of the cavity or shaped hole.

A further drawback is that during the electroerosion, the material which is detached from the element to be processed remains close to the element surface creating a layer of molten material on its surface.

An objective of the present invention is to provide an electroerosion system for producing a cavity or shaped hole in an element to be processed which allows an easy and rapid evacuation of the waste fragments during the electroerosion itself and of the exhausted dielectric fluid.

Another objective is to provide an electroerosion system that produces a cavity or shaped hole in less time than it would take to form such a cavity or shaped hole using prior art electroerosion systems.

A further objective is to provide an electroerosion system for producing a cavity or shaped hole in an element to be processed which allows a high surface quality to be obtained, while maintaining reduced processing times.

An additional objective is to provide an electroerosion system for producing a cavity or shaped hole in an element to be processed which is simple and economical to use.

### BRIEF DESCRIPTION OF THE INVENTION

These objectives according to the present invention are achieved by providing an electroerosion system for producing a cavity or shaped hole in an element to be processed as specified in the claims.

Further characteristics of the invention are indicated in the subsequent claims.

### BRIEF DESCRIPTION OF THE DRAWINGS

The characteristics and advantages of an electroerosion system for producing a cavity or shaped hole in an element to be processed according to the present invention will appear more evident from the following illustrative and non-limiting description, referring to the enclosed schematic drawing, in which:

FIG. 1 is a schematic perspective view which shows a preferred embodiment of an electroerosion system for producing a cavity or shaped hole in an element to be processed according to the present invention.

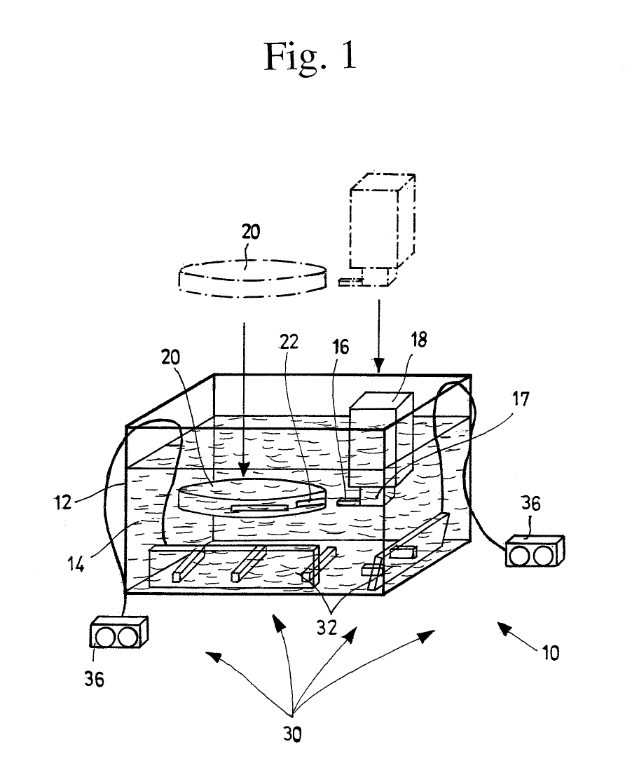

### BRIEF DESCRIPTION OF THE PREFERRED EMBODIMENT

With reference to the figure, this shows an electroerosion system 10 for the production of a cavity 22 or shaped hole in an element 20 to be processed.

Said electroerosion system 10 comprises a tank 12 containing a dielectric fluid 14 and an electrode 16 connected to an electric power supply system 18 for providing said electrode 16 with a high voltage and for creating a series of electric discharges on said metallic element 20 which is immersed, together with said electrode 16 in said dielectric fluid 14.

This allows a surface erosion of the same to be obtained in order to produce said cavity 22 or shaped hole.

Said system 10 comprises ultrasonic vibration means 30 in particular applied to the dielectric fluid 14, and the vibration means is capable of transmitting a series of ultrasonic waves at varying frequencies to said dielectric fluid 14.

This facilitates easy and rapid removal of the metallic waste fragments and exhausted dielectric fluid away from the element following electroerosion processing.

This also causes a reduction in the micro-fractures induced in the element 20 to be processed and also causes an increase in the fatigue resistance of the processed element 20 itself.

Said electroerosion system 10 is particularly effective in the production of deep electro-eroded cavities 22 as it necessarily avoids the possibility of a forced flow of dielectric fluid 14 of deforming the electrode 16 causing a contact with a consequent short circuit with the element 20 to be processed.

It also prevents the danger of short circuits caused by a possible contact due to the vibration of the element 20 to be processed or of the electrode 16.

Furthermore, the ultrasonic vibration means 30 applied to the dielectric fluid 14 causes a reduction in the quantity of eroded or molten metallic waste fragments on the surface of the cavity 22 of the element 20 to be processed.

The particular reason for this is that said ultrasonic vibration means 30 send said metallic waste fragments and the exhausted dielectric fluid outside said cavity 22 and thereby allows the entry of fresh dielectric fluid 14 into the cavity.

Said system 10 preferably comprises an electrode-holder 17, which supports said electrode 16, and also comprises an electric generator 18 in particular connected or otherwise integrated with said electrode-holder 17.

Said ultrasonic vibrations means 30 preferably comprise a series of transmitters 32 each of which is preferably a bar in particular having a “C”-shaped section, and each of the transmitters 32, moreover, is in contact with said dielectric fluid 14. As shown in the Figure the transmitters are spaced apart along the length of the respective bar member.

In particular, said series of transmitters 32 is immersed in said tank 12 in which said dielectric fluid 14 is contained.

Said ultrasonic vibration means 30 preferably comprise at least one ultrasound generator 36 connected to said series of transmitters 32.

Said ultrasonic vibration means 30 are preferably capable of transmitting to said dielectric fluid 14 a series of ultrasonic waves at a varying frequency by means of said series of transmitters 16.

Said varying frequency has an average value preferably ranging from 35 to 45 KHz, and even more preferably said varying frequency has an average value of approximately 40 KHz.

Furthermore, by allowing said dielectric fluid to vibrate by means of said ultrasonic waves, the distance between said electrode 16 and said element 20 remains advantageously unvaried.

An electroerosion system for producing a cavity or shaped hole in an element to be processed according to the present invention advantageously allows reduced processing times in both the rough-shaping and finishing phase with a consequent increase in the productivity and also a better quality of the finished surface with the same processing parameters.

It can therefore be seen that an electroerosion system for producing a cavity or shaped hole in an element to be processed according to the present invention achieves the objectives indicated above.

The electroerosion system for producing a cavity or shaped hole in an element to be processed according to the present invention thus conceived can undergo numerous modifications and variations, all included in the same inventive concept.

Furthermore, in practice, the materials used, as also the dimensions and components, can vary according to technical demands.

While the present invention has been described in connection with what are presently considered to be the most practical and preferred embodiments, it is to be understood that the present invention is not limited to these herein disclosed embodiments. Rather, the present invention is intended to cover all of the various modifications and equivalent arrangements included within the spirit and scope of the appended claims.

What claimed is:

1. An electroerosion system (10) for the production of a cavity (22) or a shaped hole in an element (20) to be processed, said system (10) comprising a tank (12) containing a dielectric fluid (14) and an electrode (16) connected to an electric power supply system (18) to supply a high voltage to said electrode (16) and to produce a series of electric discharges on said element (20) which is immersed together with said electrode (16) in said dielectric fluid (14), in order to obtain a surface erosion thereof, forming said cavity (22) or shaped hole, characterized in that it comprises ultrasonic vibration means (30) capable of transmitting a series of ultrasonic waves at a varying frequency to said dielectric fluid (14).

2. The system (10) according to claim 1, characterized in that it comprises an electrode-holder (17) which supports said electrode (16) and in that it comprises an electric generator (18).

3. The system (10) according to claim 2, characterized in that said electric generator (18) is connected to said electrode-holder (17).

4. The system (10) according to claim 2, characterized in that said electric generator (18) is integrated with said electrode-holder (17).

5. The system (10) according to claim 1, characterized in that said ultrasonic vibration means (30) comprise a series of transmitters (32) each of which is in contact with said dielectric fluid (14).

6. The system (10) according to claim 5, characterized in that each transmitter (32) is a bar in particular having a “C”-shaped section.

7. The system (10) according to claim 5, characterized in that said ultrasonic vibration means (30) comprise at least one ultrasound generator (36) connected to said series of transmitters (32).

8. The system (10) according to claim 1, characterized in that said varying frequency has an average value ranging from 35 to 45 KHz.

9. The system (10) according to claim 8, characterized in that said varying frequency has an average value of about 40 KHz.
